(19) United States
(12) Patent Application Publication
(10) Pub. No.: US 2009/0027261 A1
(43) Pub. Date: Jan. 29, 2009

(54) METHOD FOR THE CORRECTION, UPON RECEPTION IN A MOVING OBJECT, OF FAULTS AFFECTING THE TRANSMISSION OF BINARY OFFSET CARRIER RADIONAVIGATION SIGNALS

(75) Inventors: Nicolas MARTIN, Bourg Les Valence (FR); Herve GUICHON, Guilherand (FR); Marc REVOL, Upic (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/170,927

(22) Filed: Jul. 10, 2008

(30) Foreign Application Priority Data
Jul. 12, 2007 (FR) 07 05056

(51) Int. Cl. G01S 5/14

(52) U.S. Cl. 342/357.03; 342/357.04

(57) ABSTRACT

A subject of the present invention is a method for the correction, upon reception in a moving object, of faults affecting the transmission of binary offset carrier radionavigation signals, enabling this correction to be carried out in a simple and reliable manner. The method of the invention is characterized in that each component of the signal received by a conventional BPSK demodulation method is demodulated, in that the phase differential of the two signals is compensated for, source by source, and in that a coherent tracking is carried out by summing the complex outputs of the demodulation processing.

### RELATED APPLICATIONS

The present application is based on, and claims priority from, French Application Number 07 05056, filed Jul. 12, 2007, the disclosure of which is hereby incorporated by reference herein in its entirety.

### FIELD OF THE INVENTION

The present invention relates to a method for the correction, upon reception in a moving object, of faults affecting the transmission of binary offset carrier radionavigation signals, the signals originating from several reference position sources.

### BACKGROUND OF THE INVENTION

Radionavigation by satellite is used to obtain the position of the receiver through a resolution similar to that of triangulation, using pseudo-distances measured derived from signals sent by the satellites.

Some navigation systems use binary offset carrier signals formed by an RF carrier (referred to as a “central carrier”) modulated both by a square-wave subcarrier and a spreading code. This modulation exhibits a spectrum with two main lobes and an autocorrelation function with multiple peaks.

The aim of this modulation is two-fold:
to liberate the spectrum between the two lobes for other already-existing signals,
to improve the accuracy of measurements in the presence of thermal noise and multiple paths.

The drawback of this modulation is that, in order to correctly demodulate the signal, the main peak of the autocorrelation function must be found (using an ambiguity removal method) in order to have the maximum energy and to provide consistent measurements between the satellites, with the risk of being incorrect and of providing a biased pseudo-distance measurement.

Several techniques exist to carry out this ambiguity removal. They all start with a search for energy in a time/frequency domain of uncertainty. The ambiguity removal can start once the energy has been found.

The “bump-jumping” technique starts by demodulating and tracking the binary offset carrier signal on any peak, then searching, step by step, for a more powerful peak, until a peak exhibiting a maximum energy is found.

The “BPSK-like” technique involves demodulating each lobe of the received signal in parallel as if a conventional BPSK signal were involved, without local subcarrier, each of these lobes having a carrier offset to the left or to the right, and determining the maximum of the envelope (in this mode, the autocorrelation function corresponds to the envelope of the autocorrelation function of the binary offset carrier signal), which must correspond to the main peak. Once the code loop has converged on the maximum of the envelope, the receiver switches back to demodulation with a local code and a local subcarrier and thus finds itself locked to the main peak. The “BPSK-like” demodulation exhibits an unambiguous autocorrelation function, but is less accurate.

There are represented in FIG. 1, from top to bottom, diagrams of the change in time of the various components of a binary offset carrier radionavigation signal without faults, namely: its spreading code, the rectangular subcarrier, the carrier, then the carrier thus modulated, the autocorrelation function, and lastly the frequency distribution of the spectral density of the modulated signal.

When the signal has the ideal, perfectly symmetric, shape as is the case in FIG. 1, the autocorrelation function always exhibits a predominant main peak at the centre and secondary peaks on either side, of lower amplitude. In this case, it is relatively easy, by comparing the amplitudes or by making use of the envelope of this function, to determine the main peak with a high level of confidence.

However, when the signal is deformed by the analogue paths (non-ideal transfer functions on the antenna, the filters, the amplifiers and the analogue frequency-changing multipliers) within the receiver, it is possible to obtain a non-symmetric autocorrelation function, even anti-symmetric with two main peaks on either side of the centre, opposite in sign, as represented in FIG. 2. In this case, it is difficult, even impossible, to make the choice on a criterion of maximum amplitude. Furthermore, energy is lost compared to the symmetric case.

This phenomenon is due to, on the one hand, an inconsistency between the relative phase difference of the two lobes and, on the other hand, the average group delay on the two lobes. This inconsistency is due to a non-constant group delay in the passband (or in other words a non-linear phase delay in frequency). This fault is referred to as a “phase differential”. An example of this phenomenon has been represented in FIG. 3. There are represented in this drawing, from top to bottom, the changes, as a function of frequency, in the group delay, in the phase delay and in the spectral distribution of the energy of the signal exhibiting these faults. The same phenomena occur when faults affect the signals transmitted by a satellite.

### SUMMARY OF THE INVENTION

A subject of the present invention is a method for the correction, upon reception in a moving object, of faults affecting the transmission of binary offset carrier radionavigation signals, the signals originating from several reference position sources, enabling this correction to be carried out in a simple and reliable manner.

The method according to the invention is a method for the correction, upon reception in a moving object, of faults affecting the transmission of binary offset carrier radionavigation signals transmitted by at least two different sources, the signals originating from several reference position sources, and it is characterized in that each component of the signal received by a conventional BPSK demodulation method is demodulated, in that the phase differential of the two signals is compensated for, source by source, and in that a coherent tracking is carried out by summing the complex outputs of the demodulation processing.

According to another feature of the invention, the removal of ambiguity between two lobes similar in amplitude is carried out by “BPSK-like” code locking on these two lobes together with a phase locking on the central carrier.

According to yet another feature of the invention, the phase differentials due to the sources are corrected upon reception in the moving object for each source by a differential correction on the phase of the local carriers.

According to yet another feature of the invention, the phase differentials due to the sources are corrected upon reception in the moving object for each source by a complex differential rotation on the outputs of the complex correlators.

According to yet another feature of the invention, the group delay differential is compensated for upon reception in the moving object for each source by a differential correction on the phase of the local codes.

According to yet another feature of the invention, the faults of the sources are identified by the receiver of the moving object itself.

According to yet another feature of the invention, the faults due to the sources are identified on the ground, for each source in at least one fixed station receiving the corrections carried out in the receivers of the various ground-based stations in communication with this station, the various corrections thus received being averaged, filtered and transmitted to the moving object.

According to yet another feature of the invention, the averaging of the corrections between the ground stations is carried out globally for all the sources, by virtue of a least-squares filter, introducing additional unknowns, namely the biases specific to the ground-based receivers.

According to yet another feature of the invention, each source receive channel uses a single local code numerically controlled oscillator.

According to yet another feature of the invention, each source receive channel uses a single local code generator.

According to yet another feature of the invention, each source receive channel uses two clocked delay lines, one of which is parametric, to produce two local codes from the code produced by the code generator.

According to yet another feature of the invention, each source receive channel uses a single local carrier numerically controlled oscillator, and at the output of the oscillator, the phase of the local code is added to and subtracted from the local carrier phase to produce the phases of the two local carriers serving to demodulate the two components of the received signal.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a set of diagrams of signals without faults received from a radionavigation satellite, of the binary offset carrier type,

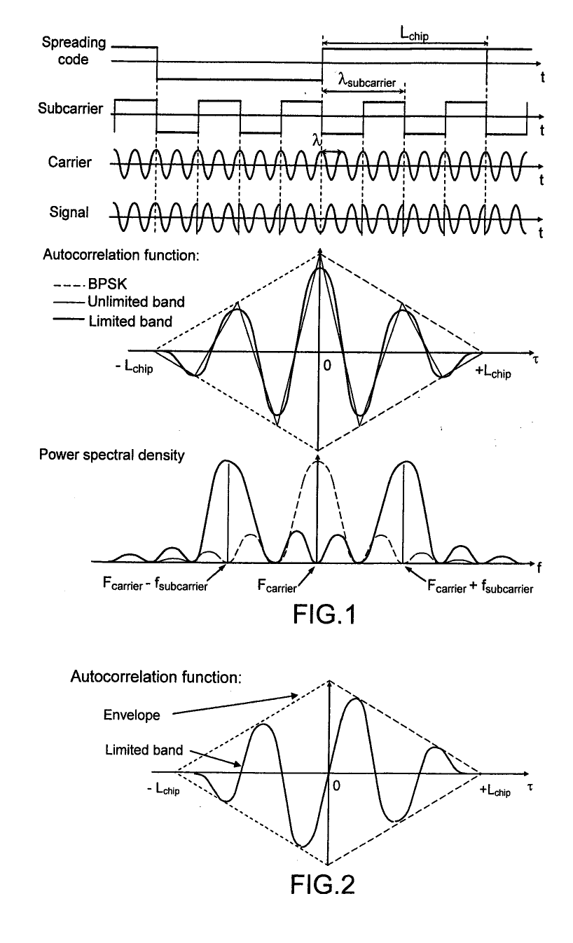

FIGS. 2 and 3 are diagrams of signals of the types of those of FIG. 1, but affected by faults,

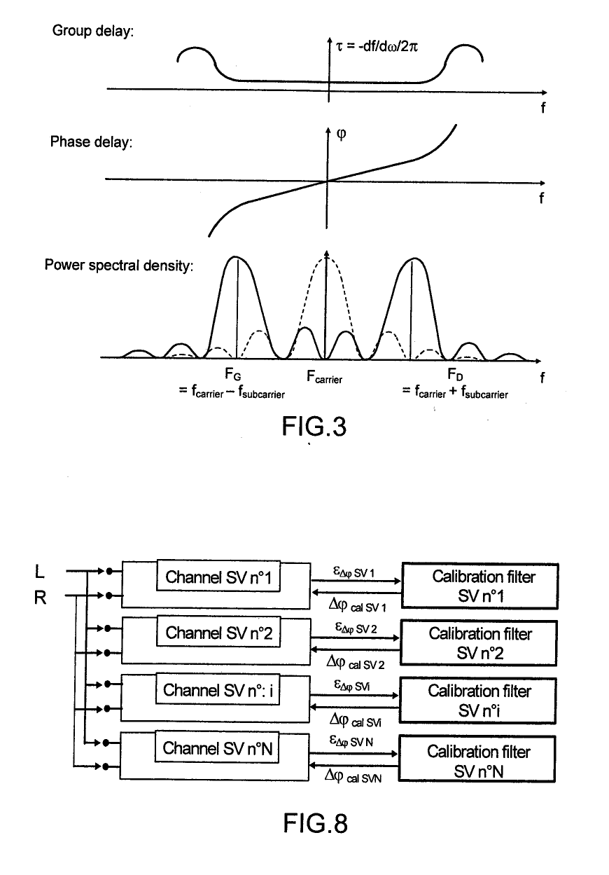

FIGS. 4 to 6 are block diagrams of three embodiments of a radionavigation receiver implementing the method of the invention,

FIG. 7 is a block diagram of an example embodiment of a parametric clocked delay line such as the one that can be used by the invention for the correction of the delay differential,

FIG. 8 is a block diagram of a calibration filter that can be used to implement the method of the invention, and

FIG. 9 is an example embodiment of a phase corrector circuit that can be used by the invention.

### DETAILED DESCRIPTION OF THE INVENTION

The invention is described below with reference to radionavigation signals originating from satellites, but it is clearly understood that the invention is not limited to only this application and that it can also be implemented when these signals originate from fixed transmitters (“pseudolites”, which is a contraction of “pseudo-satellites”, i.e. from terrestrial transmitters transmitting signals similar to those of satellites) or moving transmitters (aircraft, terrestrial vehicles, ships, etc.). Furthermore, the moving object containing the radionavigation receiver may well also be an aircraft, a terrestrial vehicle or a ship.

An important feature of the invention is that two complementary methods for tracking a two-component signal are combined, as described separately in French patents 2 841 069 (coherent tracking of two components) and 2 892 202 (compensation of analogue faults), the contents of these two patents forming part of the present description.

The first known method involves demodulating, independently, the two components comparable to BPSK signals and implementing a coherent tracking of the two components, with a single code loop and a single carrier loop, in such a way as to obtain the same performance as during binary offset carrier signal processing which would use a local subcarrier. For each received signal, the two components are demodulated using hardware means comprising two separate channels. The coherent tracking is achieved by software (post-correlation).

The second known method involves compensating for the faults due to the analogue part of the receiver (in particular when the analogue paths are separate) after these faults are identified through the satellite signals themselves.

In the case of application to a binary offset carrier signal, the two-lobe signal is comparable to a signal with two BPSK components having an identical code, but two separate carriers (but with a relationship that is deterministic and known between the phases at transmission, before the faults due to the analogue part). There is a single local code, a single numerically controlled oscillator (NCO) for the phase of the local code, a single numerically controlled oscillator for the phase of the local central carrier, and separate correlation paths between the two lobes. The method of compensation by complex product is used to correct at the output of the correlators the phase differential fault between the two paths. Thus, a correlation function is found that is ambiguous but symmetric with a main peak at its centre.

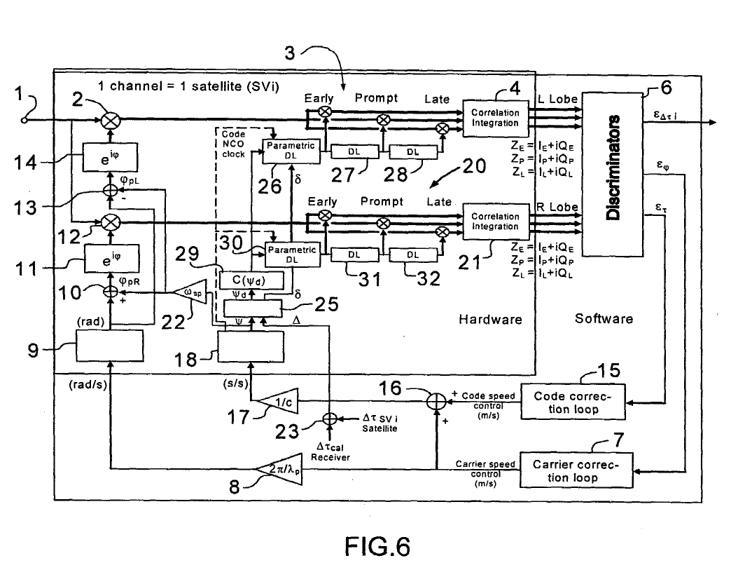

If the fault originates from satellites, the amplitude of the compensation to be applied for the signal originating from each satellite may be identified by a ground-based station and delivered to the receiver via the navigation message. The identification by the ground-based station may be carried by ground receivers, according to the calibration method described in the second known method mentioned above, by implementing a calibration filter for each tracked satellite, according to the diagram of FIG. 8. It is also possible that the receiver identifies the faults of each satellite in a prior phase, assuming that this fault does not change significantly later.

In order to explain the features of the invention, its step of coherent tracking with fault compensation will first be described. To this end, the method of coherent tracking as described in previously mentioned French patent 2 892 202 is applied, with the following simplifications for the implementation means:
a single channel with two correlation paths for the Left and Right lobes
a single local carrier numerically controlled oscillator
a single local code numerically controlled oscillator
a single code generator
the phases of carriers are obtained by combining central carrier phases and code phases
no compensation of group delay differentials (if it is assumed that the delay differential between the two lobes is negligible since there is only one analogue path for the binary offset carrier signal and there is therefore no need to correct it).

Furthermore, according to the invention, the phase differential is compensated for by taking account of the correction Δφ_{cal} produced by the calibration filter, which compensates for the receiver faults, a correction that is common to all the satellites, and corrections Δφ_{SVi} specific to each satellite. The latter corrections can be provided either by the ground-based station via the navigation message, or identified on each satellite before switching to coherent tracking.

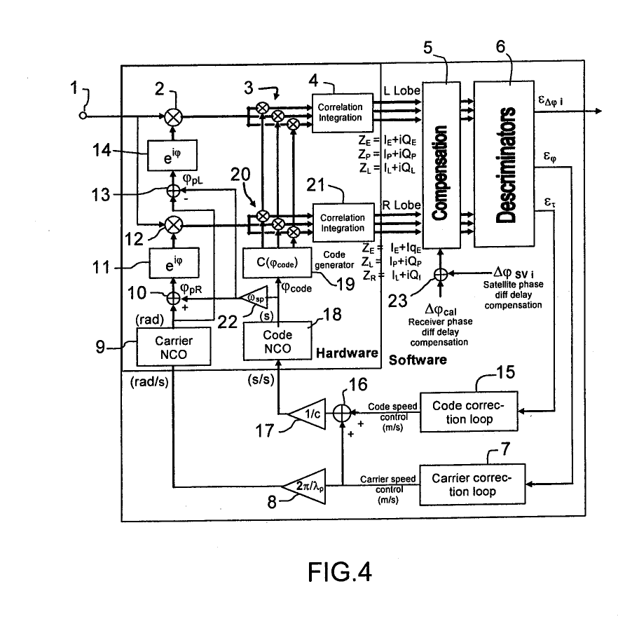

There is represented in FIG. 4 a block diagram of an example of a receive channel (at the rate of a received satellite channel, also valid for the devices of FIGS. 5 and 6) of a GNSS signal receiver for the implementation of the method of the invention with the aim of processing “binary offset carrier” signals received from satellites, with correction of local phase differentials after correlation. Since a large part of the items in this drawing have been described in abovementioned French patent 2 892 202, they are described only briefly below.

This device of FIG. 4 receives a signal 1 originating from radionavigation satellites. This signal 1 passes through a first multiplier 2, the output of which is connected to a group 3 of three correlation multipliers placed in parallel, the outputs of which are connected to a correlation integration circuit 4. The outputs of this circuit 4 are processed with the use of software by a compensator 5 followed by a group of discriminators 6, this group including at least three discriminators, for the carrier tracking loop, for the code tracking loop and for the phase differential calibration filter. The function 6 produces three types of signals at its outputs: a signal ε_{Δφi} estimating the error of compensation of the phase differential, a signal ε₁₀₀ estimating the error on the phase of the local central carrier (expressed in radians) and a signal ε_{τ} estimating the error on the phase of the local code (expressed in seconds). The latter two signals are used by a carrier phase tracking loop and by a code tracking loop respectively.

The carrier phase tracking loop includes, first of all, the following software functions: a carrier phase corrector 7 followed by an amplifier 8 bringing about an amplification of 2π/λₚ (where λₚ is the wavelength of the central carrier) for carrier speed control. The signal thus amplified is sent to hardware circuits including, respectively: a carrier numerically controlled oscillator 9 (NCO), an adder 10, a local carrier generator 11 and a multiplier 12 also receiving the signal 1. The output of the oscillator 9 is connected to an adder 13 followed by another local carrier generator 14, the output of which is connected to the multiplier 2.

The code tracking loop includes, first of all, the following software functions: a code phase corrector 15, an adder 16 (also receiving the signal from the corrector 7) followed by an amplifier 17 bringing about an amplification of 1/c. The signal thus amplified is sent to hardware circuits including, respectively: a code numerically controlled oscillator 18, a local code generator (early, prompt, late) 19, a group 20 of three code correlation multipliers, the other inputs of which are connected to the multiplier 12. Their outputs are connected to a correlation integration circuit 21 and to the inputs of the corresponding multipliers 3. Furthermore, the output of the oscillator 18 is connected via an amplifier 22 to the adder 10 and to the adder 13.

The compensator 5 receives from an adder 23 the sum of the signal Δφ_{SVi} for the compensation of the phase differential due to the satellites within range of the receiver, (this signal being produced by at least one ground-based station), and of the signal Δφ_{cal} for the compensation of the phase differential due to the receiver and produced by the calibration filter of the receiver as described in abovementioned French patent 2 892 202.

There is represented in FIG. 5 a variant of the device of FIG. 4, the circuit of FIG. 5 being different in particular in that it corrects local phase differentials before correlation. As such, this device does not include the compensation function 5 of the device of FIG. 4. In FIG. 5, the same items as those of FIG. 4 are assigned the same numerical references. The software and hardware parts of the carrier and code correction loops are the same as in FIG. 4. The difference from the device of FIG. 4 lies in the fact that the output of the software adder 23 is connected to an input of a hardware adder 24 inserted between the output of the amplifier 22 and the inputs of adders 10 and 13.

In the devices of FIGS. 4 and 5, the complex signals produced by the correlation integration circuits 4 and 21 for the abovementioned left and right lobes are, respectively, the following (for the early Z_{E}, prompt Z_{P} and late Z_{L} paths):

Z_{E a i compensated}e^{+jΔφcal}·Z_{E a i} Z_{E b i compensated}=e^{-jΔφcal}·Z_{E b I}

Z_{P a i compensated}=e^{+jΔφcal}·Z_{P a i} Z_{P b i compensated}=e^{-jΔφcal}·Z_{P b I}

Z_{L a i compensated}=e^{+jΔφcal}·Z_{L a i} Z_{L b i compensated}=e^{-jΔφcal}·Z_{L b i}

The device represented in FIG. 6 relates to the group delay differential correction, the principle of this correction being similar to that of phase differential correction of the device of FIG. 5. In particular, this device includes only one numerically controlled oscillator (NCO) and only one code generator in the code tracking loop. The same items as those of FIG. 5 are assigned the same numerical references.

In the device of FIG. 6, the carrier correction loop is the same as in the device of FIG. 5. However, the code tracking loop is different in its hardware part. In this hardware part, the output of the oscillator 18 (Ψ) is connected via a corrector circuit 25 specifically for group delay differential correction, the parameter processing output (δ) of which is connected to the parameter input of a clocked parametric delay line 26 (clocked by the clocked signal H_{code} mentioned below) followed by two conventional delay lines 27, 28. The outputs of the delay lines 26, 27 and 28 are each connected to an input of “early”, “prompt” and “late” multipliers respectively, of the group of multipliers 3. The clocked parametric delay line 26 provides for shifting the code of the Left path with respect to that of the Right path, by an interval that is dependent on the value of the group delay correction.

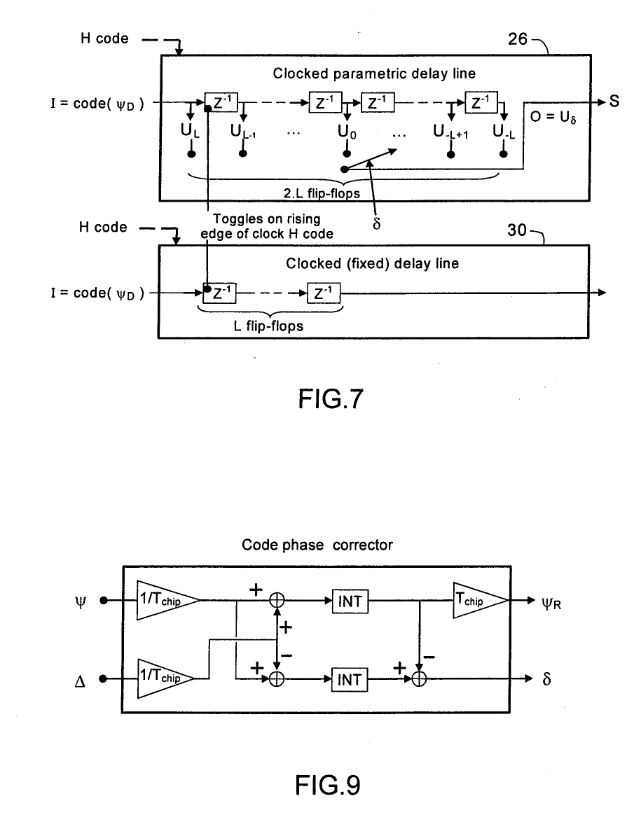

The circuit 25 is implemented in a manner that is known per se (see an example embodiment in FIG. 9), taking into account the following requirements. It is desired to generate two codes, one to demodulate the left lobe and another to demodulate the right lobe, from Ψ_{L} and Ψ_{R}. It is desired to have Ψ_{R}=integer part[(Ψ+Δ)/T_{chip}]×T_{chip} and Ψ_{L}=integer part[(Ψ−Δ)/T_{chip}]×T_{chip}. Since it is desired to avoid having two code generators, the code of the left lobe is produced from the code of the right lobe (generated from Ψ_{R}) by advancing it by an integer number of chips equal to (Ψ_{L}−Ψ_{R})/T_{chip}=δ. Since a signal cannot be advanced, the code of the right lobe is delayed by a constant integer number of chips L equal to the maximum value of δ using a delay line clocked by Hcode and the code of the left lobe is delayed by a variable integer number of chips L−δ using a parametric delay line clocked by Hcode. The delaying of L code chips, common to both lobes, does not have any effect on the performance of the signal processing.

The output Ψᵣ of the corrector circuit 25 is the local code phase at the input of the code generator 29 which produces a local code at the input of the clocked parametered delay line 26, and at the input of the clocked delay line 30 (clocked by the clock signal H_{code} mentioned below). This delay line 30 is followed by two conventional delay lines 31 and 32. The outputs of the delay lines 30, 31 and 32 are each connected to an input of the “early”, “prompt” and “late” multipliers, respectively, of the group of multipliers 20. Furthermore, the code clock signal output (H_{code}) of the code numerically controlled oscillator 18 is connected to the clock signal inputs of the clocked delay lines 26 and 30. The corrector 25 additionally receives the signal (Δ) from the adder 23. The signal H_{code} is a digital signal having a rising edge each time the integer part of the phase Ψ at the output of the oscillator 18 increases by 1. The various variables relating to the code phase corrector include:

Ψ_{R}=integer part[(Ψ+Δ)/T_{chip}]×T_{chip}

δ=integer part[(Ψ−Δ−Ψ_{R})/T_{chip}], i.e.:

δ=integer part[(Ψ−Δ)/T_{chip}]−Ψ_{R}/T_{chip}

where T_{chip} is the duration of a chip of the spreading code.

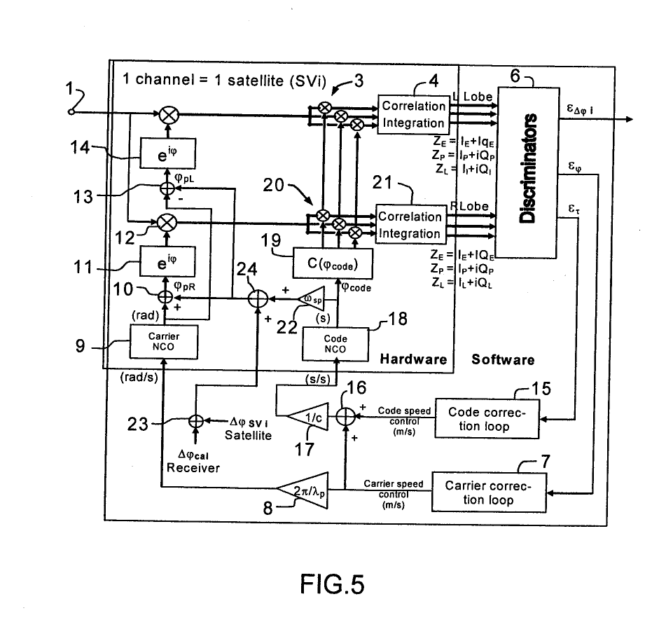

There is represented in FIG. 7 an example embodiment of the delay line 26 and of the delay line 30. The delay line 26 includes several cascaded flip-flops represented by the symbol Z⁻¹ (the number 2L of which is equal to the maximum number of unitary delays to be obtained). These flip-flops are bistable flip-flops toggling upon each rising edge of the clock signal H_{code}. The delay line 26 receives as input the local code relating to the satellite concerned, produced by the code generator 29. At the output of this parametric delay line is the local code delayed by L+δ code chip periods by the L+δ first series of flip-flops.

The delay line 30 includes L cascaded bistable flip-flops, but since it is not of the parametric type, only the output of the last flip-flop forms the output of the delay line. Its input signal is the same as that of the flip-flop 26, as mentioned above. At the output of this delay line is the local code delayed by L code chip periods by the L series of flip-flops.

There is represented in FIG. 8 the block diagram of an example of a device for determining the differentials of propagation differential delay Δτ_{cal} and of phase differential delay Δφ_{cal} of the positioning receiver for each satellite received.

The N pairs of lobes received from N satellites, i.e. the left and right lobes, are applied to N dual-frequency receive channels R1, R2, . . . Ri . . . RN of the same type as one of those described with reference to FIGS. 4 to 6. Each dual-frequency receiver channel delivers to a calibration filter, which is specific to it (SVn^{o}1 to SVn^{o}N), the estimated values of the error of correction (or calibration) of the phase differential ε_{ΔφSVi} (where i=1 to N) in order to calculate the phase differential correction Δφ_{cal SVi} which is applied to the adders 23 of the channel i. Likewise, if necessary, each dual-frequency receiver channel delivers to a calibration filter, which is specific to it (SVn^{o}1 to SVn^{o}N), the estimated values of the error of correction (or calibration) of the delay differential Δτ_{cal SVi} (where i=1 to N) in order to calculate the delay differential correction Δτ_{cal SVi} which is applied to the other adder 23 of the channel i.

The role of the filters is to filter, in the time-domain, the measurements received from the satellites in order to update the corrections Δφ_{cal SVi} and Δτ_{cal SVi}, minimizing the impact of the measurement errors on the accuracy of the calibration.

As regards the removal of ambiguity with the aim of determining the main peak of the autocorrelation function, the energy search phase is carried out conventionally by the “BPSK-like” method on one lobe or two lobes (non-coherent summing of energies).

The transition phase starts once the receiver has found energy and provides for switching to nominal binary offset carrier signal tracking locked on the main peak. It includes a first step of Doppler convergence, by virtue of a frequency loop, and a second step of the removal of ambiguity of the binary offset carrier signal using a “BPSK-like” code loop on the two lobes, aided by a carrier phase loop locked on the central carrier.

The ambiguity removal itself uses for example the method described in the document: “ION GPS/GNSS 2003, 9-12 Sep. 2003, Portland, Oreg.”—Pages 188 to 198, Authors: N. Martin, V. Leblond, G. Guillotel, V. Heiries

Faults of the satellites can be identified by the user receiver itself, using the method described in the previously-mentioned patent (no. 2 892 202) but with a phase differential calibration filter and a delay differential calibration filter for each satellite, as in FIG. 8. In order to be least sensitive to local disturbances (thermal noise, interference, multiple paths) it is recommended to have a filtering horizon (or period) as long as possible (compatible with the changes in faults of the satellites over time) and to save the values of the corrections between two uses of the receiver. A Kalman filter forms a suitable solution.

Each calibration filter (see FIG. 8) produces a correction Δφ_{SV i} for satellite SV n^{o}i from a phase differential discriminator ε_{Δφi}. There is no longer a common correction Δφ_{cal}, since it is already included in Δφ_{SVi}. Likewise for the delay differential, if necessary.

It is nevertheless preferable to identify the faults on the ground using fixed receivers which average the calibration errors in space and in time: For each satellite i of the constellation, the phase differential corrections Δφ_{SVi} and delay differential corrections Δτ_{SVi}, relating to the satellite i and estimated by all the ground receivers in sight of the satellite i, are averaged, filtered and transmitted to the moving user receiver via the navigation message. In this case the moving receiver implements the calibration method as described in abovementioned French patent 2 892 202, but adding in each satellite channel i, via the adders 23 of FIGS. 4, 5 and 6, respectively, the corrections Δφ_{SVi} and Δτ_{SVi} to the corrections Δφ_{cal} and Δτ_{cal} estimated in the moving receiver by the phase differential calibration filter and the delay differential calibration filter. Each ground receiver RX j implements the method described in abovementioned French patent 2 892 202, but with a calibration filter per visible satellite SV i, as described in FIG. 8, in order to produce an estimate of the phase differential Δφ_{SVi RXj} and of the delay differential Δτ_{SVi RXj}.

In order to take into account faults of analogue paths specific to the ground-based receivers and which are likely to bias the estimations Δφ_{SVi RXj} and Δτ_{SVi RXj}, it is wise to carry out the average of the estimated corrections using a least-squares filter introducing additional unknowns, namely the biases of the receivers Δ _{RXj}.

Ground receiver no. 1:

$$( \begin{matrix}Δ {ϕ}_{SV 1} + Δ {ϕ}_{RX 1} = Δ {ϕ}_{SV 1 RX 1} \\ Δ {ϕ}_{SV 2} + Δ {ϕ}_{RX 1} = Δ {ϕ}_{SV 2 RX 1} \\ ⋮ \\ Δ {ϕ}_{SVN} + Δ {ϕ}_{RX 1} = Δ {ϕ}_{SVN RX 1}\end{matrix}$$

Ground receiver no. 2:

$$( \begin{matrix}Δ {ϕ}_{SV 1} + Δ {ϕ}_{RX 2} = Δ {ϕ}_{SV 1 RX 2} \\ Δ {ϕ}_{SV 2} + Δ {ϕ}_{RX 2} = Δ {ϕ}_{SV 2 RX 2} \\ ⋮ \\ Δ {ϕ}_{SVN} + Δ {ϕ}_{RX 2} = Δ {ϕ}_{SVN RX 2}\end{matrix} \\ ⋮$$

Ground receiver no. M:

$$( \begin{matrix}Δ {ϕ}_{SV 1} + Δ {ϕ}_{RXM} = Δ {ϕ}_{SV 1 RXM} \\ Δ {ϕ}_{SV 2} + Δ {ϕ}_{RXM} = Δ {ϕ}_{SV 2 RXM} \\ ⋮ \\ Δ {ϕ}_{SVN} + Δ {ϕ}_{RXM} = Δ {ϕ}_{SVN RXM}\end{matrix}$$

### Unknowns:

Δφ_{SVi}, i=1, 2, . . . N (Correction of the phase differential produced by the ground segment for satellite i and transmitted to the user receivers)
Δφ_{RXj} j=1, 2, . . . M (Phase differential specific to ground receiver j)

### Measurements:

Δφ_{SVi RXj}, i=1, 2, . . . N and j=1, 2, . . . M (Phase differential estimated by receiver j on satellite i)
The system is written in the form:

H·X=Z

X=[Δφ_{SV1}, Δφ_{SV2}, . . . , Δφ_{SVN}, Δφ_{RX1}, Δφ_{RX2}, . . . , Δφ_{RXM}]^{T}

Z=[Δφ_{SV1 RX1}, Δφ_{SV2 RX1}, . . . , Δφ_{SVN RX1}, Δφ_{SV1 RX2}, . . . , Δφ_{SVN RXM}]^{T}

Least-squares solution: X=(H·H^{T})⁻¹·H^{T}·Z

(Of course, this method is applied in the same way to the delay differential Δτ)

There are N+M unknowns and as many equations per ground receiver as visible satellites, given that on average a third of the satellites of the constellation are visible from each ground receiver. Since more equations than unknowns are necessary, a half-dozen ground stations distributed all around the Earth should be sufficient to identify all the corrections of all the satellites of the constellation. Additional ground receivers are useful to improve the accuracy of the corrections.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Method for the correction, upon reception in a moving object, of faults affecting the transmission of binary offset carrier radionavigation signals, the signals originating from several reference position sources, comprising the steps of: demodulating each component of the signal received by a conventional BPSK demodulation method, compensating for a phase differential of the two signals, source by source, and carrying out coherent tracking by summing the complex outputs of the demodulation processing.

2. The method according to claim 1, wherein the removal of ambiguity between two lobes similar in amplitude is carried out by “BPSK-like” code locking on these two lobes together with phase locking on the central carrier.

3. The method according to claim 1, wherein the phase differentials due to the sources are corrected upon reception in the moving object for each source by a differential correction on the phase of the local carriers.

4. The method according to claim 1, wherein the phase differentials due to the sources are corrected upon reception in the moving object for each source by a complex differential rotation on the outputs of the complex correlators.

5. The method according to claim 1, wherein the group delay differential is compensated for upon reception in the moving object for each source by a differential correction on the phase of the local codes.

6. The method according to claim 4, wherein the faults of the sources are identified by the receiver of the moving object itself.

7. The method according to claim 1, wherein the faults due to the sources are identified on the ground, for each source, in at least one fixed station receiving the corrections carried out in the receivers of the various ground-based stations in communication with this station, the various corrections thus received being averaged, filtered and transmitted to the moving object.

8. The method according to claim 7, wherein the averaging of the corrections between the ground stations is carried out globally for all the sources, by virtue of a least-squares filter, introducing additional unknowns, namely the biases specific to the ground-based receivers.

9. The method according to claim 1, wherein each source receive channel uses a single local code numerically controlled oscillator.

10. The method according to claim 1, wherein each source receive channel uses a single local code generator.

11. The method according to claim 1, wherein each source receive channel uses two clocked delay lines, one of which is parametric, to produce two local codes from the code produced by the code generator.

12. The method according to claim 1, wherein each source receive channel uses a single local carrier numerically controlled oscillator, and in that at the output of the oscillator, the phase of the local code is added to and subtracted from the local carrier phase to produce the phases of the two local carriers serving to demodulate the two components of the received signal.

13. The method according to claim 1, wherein the sources are one at least of the following systems: geo-positioning satellites, fixed pseudolites, moving pseudolites, moving transmitters on aircraft, terrestrial vehicles or ships.

14. The method according to claim 2, wherein the phase differentials due to the sources are corrected upon reception in the moving object for each source by a differential correction on the phase of the local carriers.

15. The method according to claim 2, wherein the phase differentials due to the sources are corrected upon reception in the moving object for each source by a complex differential rotation on the outputs of the complex correlators.

16. The method according to claim 2, wherein the group delay differential is compensated for upon reception in the moving object for each source by a differential correction on the phase of the local codes.

17. The method according to claim 5, wherein the faults of the sources are identified by the receiver of the moving object itself.

18. The method according to claim 2, wherein the faults due to the sources are identified on the ground, for each source, in at least one fixed station receiving the corrections carried out in the receivers of the various ground-based stations in communication with this station, the various corrections thus received being averaged, filtered and transmitted to the moving object.

19. The method according to claim 2, wherein each source receive channel uses two clocked delay lines, one of which is parametric, to produce two local codes from the code produced by the code generator.

20. The method according to claim 2, wherein each source receive channel uses a single local carrier numerically controlled oscillator, and in that at the output of the oscillator, the phase of the local code is added to and subtracted from the local carrier phase to produce the phases of the two local carriers serving to demodulate the two components of the received signal.
